(19) United States
(12) Patent Application Publication
(10) Pub. No.: US 2023/0062806 A1
(43) Pub. Date: Mar. 2, 2023

(54) Hardtop Cart

(71) Applicant: Brian Goldwitz, Waterbury, CT (US)

(72) Inventor: Brian Goldwitz, Waterbury, CT (US)

(21) Appl. No.: 17/893,740

(22) Filed: Aug. 23, 2022

Related U.S. Application Data
(60) Provisional application No. 63/236,681, filed on Aug. 24, 2021.

(51) Int. Cl. B62B 3/10; B62B 3/02

(52) U.S. Cl. CPC B62B 3/108; B62B 3/02

(57) ABSTRACT

The current invention is a hardtop cart that will store, hold and move a vehicle hardtop. It has a frame with a base that has wheels on which the hardtop can be placed and stored. It has clips and angled frame components that hold and secure the hardtop. It also may have in the preferred embodiment an adjustable securing bar that holds the hardtop on the cart. The cart will have an angled back bar which hold the hardtop angled into the clips.

### RELATED APPLICATIONS

This application is the non-provisional of provisional application 63/236,681 filed on Aug. 24, 2021 and claims its priority date.

### TECHNICAL FIELD

The technology discussed below relates hardtop carts and more particularly making it easier to remove, store and move the hardtop.

### BACKGROUND

The changes in technology and needed functionality with vehicles. This is especially true with vehicle like jeeps and SUVs.

Owners of jeeps and SUV (Sports Utility Vehicles with removable hardtops will at time desire to remove those hardtops to enjoy driving without the confines of the hardtop enclosure. When removed the hardtop needs to be stored safely and in a way that makes it easy to move and store.

There is still room for improvement in the art.

### SUMMARY

The current invention is a hardtop cart that will store, hold and move a vehicle hardtop cart. The a cart can store and easily move a vehicle hardtop. Th cart has a frame with a base that has wheels on which the hardtop can be placed and stored. The cart has clips and angled frame components that hold and secure the hardtop. It also may have in the preferred embodiment, an adjustable securing bar that holds the hardtop on the cart. The cart will have an angled back bar which hold the hardtop angled into the clips.

These are improvements over the current art.

### DRAWINGS

FIG. 1 is a view of the cart without the hardtop;

FIG. 2 is a front view of the cart without the hardtop;

FIG. 3 is a side view of the cart without the hardtop;

FIG. 4. is a front view of the hardtop cart with the hardtop on the cart;

FIG. 5. is another front view of the hardtop cart the hardtop on the cart; and

FIG. 6. is a back view of the cart with the hardtop on the cart.

### DETAILED DESCRIPTION

The illustrations presented herein are, in some instances, not actual views of any particular framing devices or components thereof, but may be idealized representations which are employed to describe the present disclosure. Additionally, elements common between figures may retain the same numerical designation.

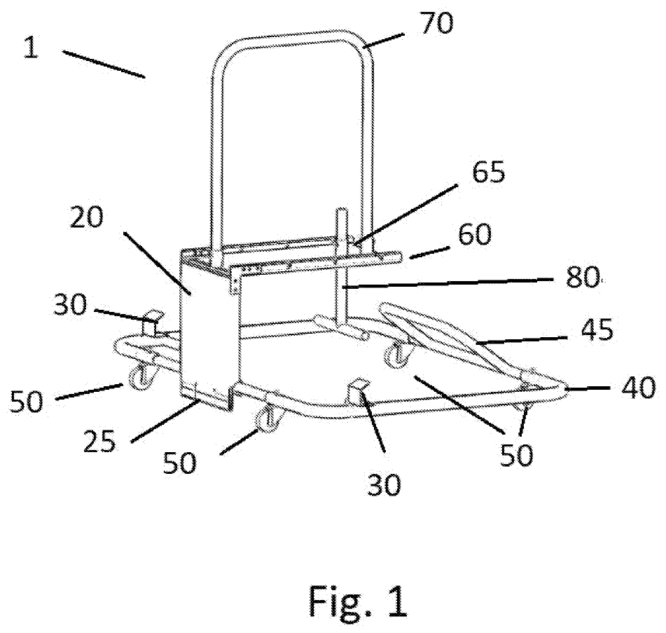

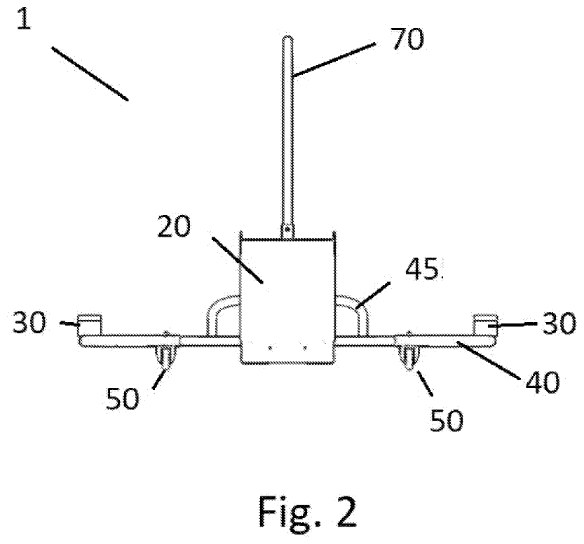

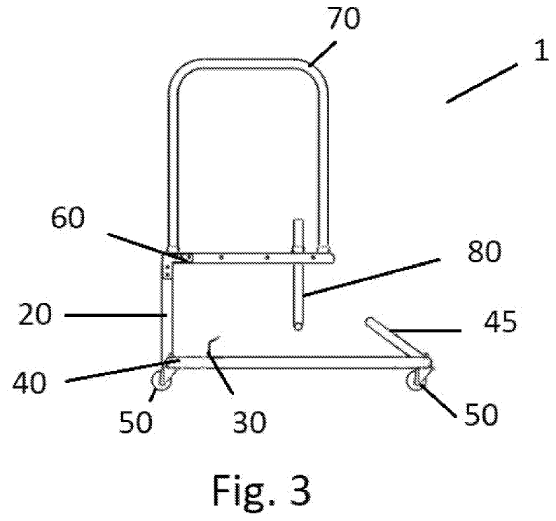

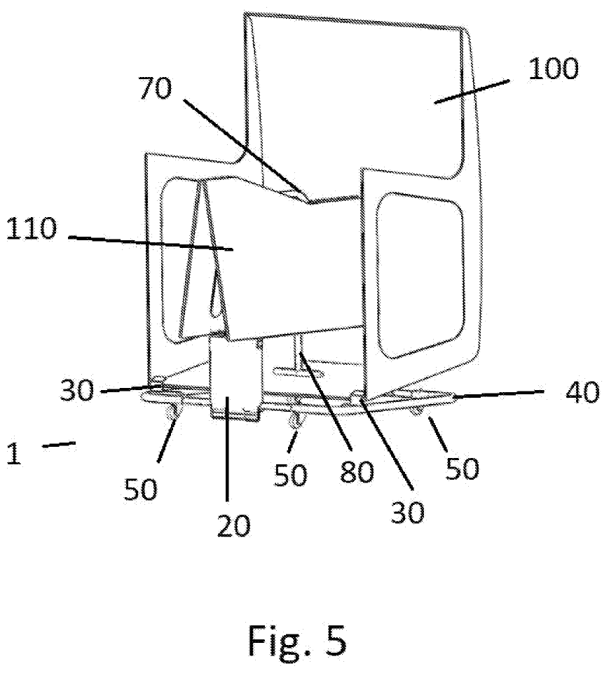

The current invention is an improved hardtop cart as shown in FIGS. 1 through 6.

FIGS. 1 through 6 show a cart 1 that can store and easily move a vehicle hardtop 100. It has a frame with a base 40 with wheels 50 on which the hardtop 100 can be placed and stored. It has clips 30 and angled frame 45 components that hold and secure the hardtop 100. It also may have in the preferred embodiment an adjustable securing bar 80 that holds the hardtop on the cart 1. The cart 1 will have an angled frame 45 which hold the hardtop angled into the clips 30.

The cart 1 consists of a frame that has a base 40 which is rectangular in shape with rounded edges. In the preferred embodiment, the base 40 is can be made of cylinder tubing for safety and to prevent damage but it can be made out of bars or any similar shapes or materials. The base 40 has a front bar, a let side bar, a right side bar and a back bar the form the rectangular shape where the front bar and the back bar are the same length and the right side bar and the left side bar are the same length and where the ends of the right and left bar curve at 90 degrees to connect to the front and back bar as shown in FIG. 1-6.

On the bottom side of the base 40, the cart 1 will have a number of wheels 50 connected to the base 40. In the preferred embodiment there will be one wheel 50 or wheel assemble on each corner of the base 40.

Positioned in the back of base 40 is an angled frame 45. In the preferred embodiment, the angled frame 45 extends at an approximate 45 degree angle up from the base 40. The angled frame 45 is connected to the base 40 at two points on the left side and the right side of the back of the base 40 where the angled frame 45 extends out from the base 40 at the two points with a cross bar that connects the two extension to each other. As with the base 40 the connections between the cross bar and the extensions have rounded edges.

The current invention has clips 30 that are positioned located on the left side bar and the right side bar an equaled distance from the front bar. The clips 30 extend perpendicular from the top of the base 40 and then bend at an angle towards the back of the base 40.

The cart 1 has a front support panel 20 attached to the middle of the front bar. It extends slightly below the front bar and extends up perpendicular to the front bar. The front support panel 20 will have a top flat lip. In some embodiments, the front support panel 20 is attached to the front bar by a hinge 25 which allows the front support panel 20 and its attachments to pivot forward.

The cart 1 has angled brackets 60 that attach to the left and right of the top of the front support panel 20. The angled brackets 60 extend up from the top of the front support panel 20 and the have a 90 degree angle towards the back of the cart 1. In the preferred embodiment there are two angled brackets 60 one on each side of the front support panel 20 where the angled brackets 60 are parallel with each other. The ends away from the support panel 20 of the angled brackets 60 will be connected by a connection mean 65 which can be a chain or a solid bar.

Extending from one of the angled bars 60 will be an adjustable securing bar 80. This adjustable securing bar 80 is attached to one of the angled bars 60 and extends down to hold the hardtop 100 in place. In the preferred embodiment, it will have an adjustment means 85 such as springs or ball and joint or similar means. The adjustable securing bar 80 will be in the shape of an upside down “T”. The adjustment means 85 can be springs, or ball and socket or screws or some other type of means.

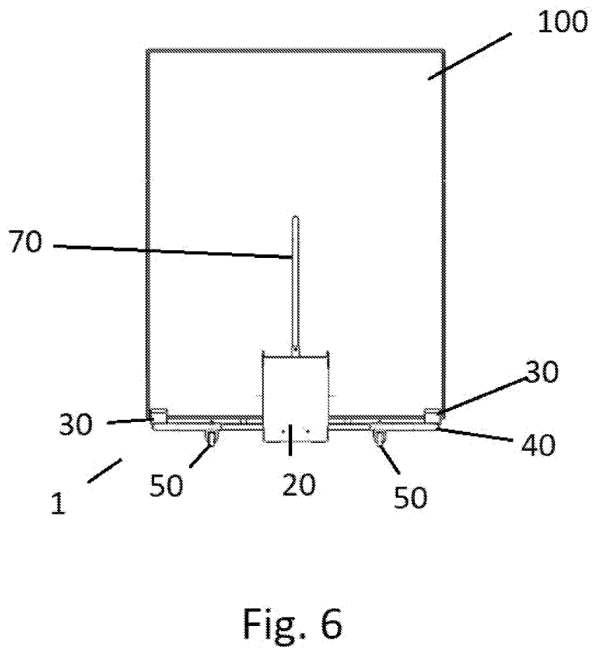

The cart 1 will have an upper support bar 70 that extends up from the middle of the front support panel 20 then curves towards the back of the cart 1 and curves down to connect to the connection means 65 or one of the angled brackets 60. It can be used to support other removable components 110 such as doors or panels as shown in FIG. 6.

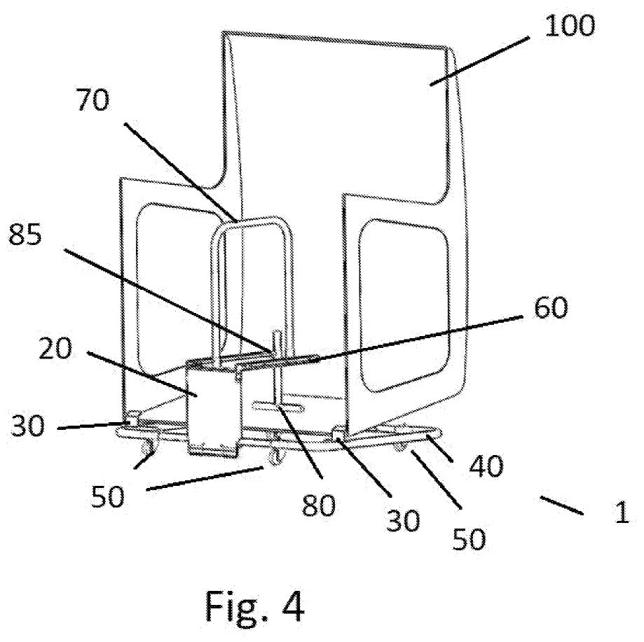

As shown in FIGS. 4, 5 and 6, the hardtop 100 is loaded on to the cart 1 with the back bottom edge being placed into the clips 30 while being angled down by the angled support bar 45 with the adjustable securing bar 80 holding it into place. With it being held in place, the cart 1 can easily move it using the wheels 50. As shown in FIG. 6, other components 110 can be place on the cart 1 using the upper support bar 70. The components 110 can rest on the front support panel 20 and the connection means 65.

FIG. 6 is a front view of the hardtop cart 1 with the hardtop 100 on the cart 1.

The various features associate with the examples described herein and shown in the accompanying drawings can be implemented in different examples and implementations without departing from the scope of the present disclosure. Therefore, although certain specific constructions and arrangements have been described and shown in the accompanying drawings, such embodiments are merely illustrative and not restrictive of the scope of the disclosure, since various other additions and modifications to, and deletions from, the described embodiments will be apparent to one of ordinary skill in the art.

What is claimed is:

1. A device comprising:
a hardtop cart having a base with a plurality of wheels the extend from the bottom of said base, with wheels, a plurality of clips that extend upward from the base, an angled frame, a frame support panel with a plurality of angled brackets with a securing bar.

2. The device according to claim 1 further comprising:
the base consists of a front bar and a back bar that are attached to a left bar and a right bar.

3. The device according to claim 1 further comprising:
where the base is rectangular in shape.

4. The device according to claim 1 further comprising:
where the securing bar is adjustable.

5. The device according to claim 2 further comprising:
where the clips extend perpendicularly with a bend towards the back bar of the base.

6. The device according to claim 1 further comprising:
where the angled brackets are parallel to each other.

7. The device according to claim 6 further comprising:
where the angled brackets ends are attached to each other with a connection means.

9. The device according to claim 2 further comprising:
where the front bar and the back bar are the same lengths.

10. The device according to claim 2 further comprising:
where the left bar and the right bar are the same lengths.

11. The device according to claim 2 further comprising:
where there are four wheels one in each corner of the base.

12. The device according to claim 2 further comprising:
where the angle bar extends upward from the back bar.

13. The device according to claim 2 further comprising:
where the clips are an equal distance from the front bar.

14. A device comprising:
a hardtop cart having a base with a plurality of wheels the extend from the bottom of said base, with wheels, a plurality of clips that extend upward from the base, an angled frame, a frame support panel with a plurality of angled brackets with an adjustable securing bar where the base is rectangular in shape and consists of a front bar and a back bar that are attached to a left bar and a right bar.

15. The device according to claim 14 further comprising:
where the clips extend perpendicularly with a bend towards the back bar of the base.

16. The device according to claim 14 further comprising:
where the angled brackets are parallel to each other and are attached to each other with a connection means.

17. The device according to claim 14 further comprising:
where the front bar and the back bar are the same lengths and the left bar and the right bar are the same lengths.

18. The device according to claim 14 further comprising:
where there are four wheels one in each corner of the base.

19. The device according to claim 14 further comprising:
where the angle bar extends upward from the back bar.

20. The device according to claim 14 further comprising:
where the clips are an equal distance from the front bar.
